(19) United States
(12) Patent Application Publication
(10) Pub. No.: US 2026/0127015 A1
(43) Pub. Date: May 7, 2026

(54) END-TO-END MOBILE USER INTERFACE NAVIGATION WITH VISION LANGUAGE ACTION MODELS

(71) Applicant: Apple Inc., Cupertino, CA (US)

(72) Inventors: Di FENG, Palo Alto, CA (US); Keen YOU, Cupertino, CA (US); Zhen YANG, Santa Clara, CA (US); Anuj MAHAJAN, San Jose, CA (US); Harsh AGRAWAL, New York, NY (US); Meng-Ta CHOU, Los Gatos, CA (US); Andres ROMERO MIER Y TERAN, San Jose, CA (US); Adolfo LOPEZ MENDEZ, Sunnyvale, CA (US); Kenneth JUNG, Sunnyvale, CA (US); Abhishek SUNDARARAJAN, Campbell, CA (US); Pengfei DOU, San Jose, CA (US); Haotian ZHANG, Sunnyvale, CA (US); Zifeng HUANG, Redwood City, CA (US); Eldon K. SCHOOP, Seattle, WA (US); Alexander TOSHEV, San Francisco, CA (US); Jeffrey W. NICHOLS, San Diego, CA (US); Yinfei YANG, Sunnyvale, CA (US); Zhe GAN, Kirkland, WA (US); Mohana Prasad SATHYA MOORTHY, San Jose, CA (US)

(21) Appl. No.: 19/294,210

(22) Filed: Aug. 7, 2025

Related U.S. Application Data
(60) Provisional application No. 63/716,230, filed on Nov. 4, 2024.

(51) Int. Cl. G06F 9/451; G06F 40/284; G06F 40/40; G06T 3/40

(52) U.S. Cl. CPC G06F 9/453; G06F 40/284; G06F 40/40; G06T 3/40; G06T 2200/24

(57) ABSTRACT

The subject technology provides for end-to-end mobile user interface navigation with vision language action models. An apparatus may receive a language instruction and a visual input from a user interface (UI) of an electronic device. The apparatus can tokenize the language instruction and the visual input separately. The apparatus can process the tokenized language instruction and the tokenized visual input using a multi-modal large language model to generate one or more action outputs. The apparatus also can convert the action outputs into executable commands that cause the electronic device to perform navigation tasks on the UI.

### CROSS-REFERENCE TO RELATED APPLICATIONS

The present application claims the benefit of U.S. Provisional Application No. 63/716,230, entitled “END-TO-END MOBILE USER INTERFACE NAVIGATION WITH VISION LANGUAGE ACTION MODELS”, filed Nov. 4, 2024, the entirety of which is incorporated herein for reference.

### TECHNICAL FIELD

The present description generally relates to end-to-end mobile user interface navigation with vision language action models.

### BACKGROUND

Machine learning has seen a significant rise in popularity in recent years due to the availability of training data, and advances in more powerful and efficient computing hardware. Machine learning may utilize models that are executed to provide predictions in particular applications. Large language models are characterized by their substantial size, often comprising hundreds of millions to billions of parameters. These models require significant computational power and memory for training and inference. However, deploying large machine learning models across different environments presents challenges related to model performance in these environments.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in accordance with one or more implementations.

FIG. 2 is a flow chart of an example process that may be performed for end-to-end mobile user interface navigation with vision language action models in accordance with one or more implementations.

FIG. 3 illustrates an example multi-step navigation flow for end-to-end mobile user interface navigation with vision language action models in accordance with one or more implementations.

FIG. 4 illustrates a block diagram of an example autonomous UI agent architecture for end-to-end mobile user interface navigation with vision language action models in accordance with one or more implementations.

FIG. 5 illustrates example visual question answering formats for training a large language model agent for end-to-end mobile user interface navigation with vision language action models in accordance with one or more implementations.

FIG. 6 illustrates an example human-annotated episode flow for end-to-end mobile user interface navigation with vision language action models in accordance with one or more implementations.

FIG. 7 illustrates a block diagram of an exploration mechanism to generate auto-label data for end-to-end mobile user interface navigation with vision language action models in accordance with one or more implementations.

FIG. 8 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Powered by large language models and multi-modal foundation models, autonomous agents capable of controlling mobile devices to perform tasks traditionally executed by humans represent emerging technology with significant potential to impact the computer industry and user interfaces (UIs). In one or more implementations, these autonomous UI agents can display a cooking recipe on a mobile device while a user's hands remain occupied with other tasks, such as washing dishes, or transcribe a meeting reminder while the user is engaged in activities like driving. By automating interactions with mobile applications that typically demand manual effort, such autonomous UI agents can provide beneficial improvements in productivity and safety across daily activities.

Recent efforts in autonomous UI agents focus on enabling models to interpret natural language instructions and understand the state of mobile devices by processing visual input, such as raw screenshots, application UI trees, or outputs from specialized UI detection models. These agents can predict actions—such as tap, type, and scroll—that are subsequently executed through the device's user interface. In one or more implementations, autonomous UI agents may be configured to predict low-level action policies specific to mobile device control, positioning them as a subset of Vision Language Action (VLA) models within the broader fields of artificial intelligence (AI) and robotics.

Despite recent advancements, several major challenges remain for autonomous UI agents. A first challenge may be the complex modular design required by most agents, which rely on external UI detectors or application trees to identify UI elements and perform zero-shot or few-shot navigation through large, off-the-shelf multi-modal models. These agents may operate in a multi-agent workflow involving planning, action, and evaluator agents. While this structure can deliver beneficial performance across diverse navigation tasks, it also increases modeling complexity and inference time, complicating optimization and making these systems more prone to errors.

A second challenge may be in the limited online evaluation and re-planning capabilities of existing models. In one or more implementations, early models simplify the agent workflow by using a VLA model to predict actions directly from raw screenshots in an end-to-end framework. These autonomous UI agents can be trained on human-recorded episodes through imitation learning and evaluated solely on offline datasets, with predicted actions compared frame-by-frame to annotated actions using human reference traces as history inputs. In one or more other implementations, offline evaluation may not fully represent real-world performance, where multiple paths may exist to complete navigation tasks, and agents benefit from re-planning if mistakes occur.

A third challenge may be the lack of high-quality navigation datasets for mobile devices. In one or more implementations, publicly available mobile UI navigation datasets are restricted to certain mobile device platforms, which biases existing models toward specific applications. In one or more implementations, prominent datasets can contain noisy and redundant human traces and lack the comprehensive annotations, such as human-annotated single-step prompts, needed for effective UI navigation.

To address these limitations, embodiments of the subject technology provide for an autonomous UI agent implemented as a large language model (LLM) agent can serve as an end-to-end VLA model configured for mobile UI navigation tasks, utilizing multi-modal large language models to control mobile devices in an end-to-end manner. The autonomous UI agent may include model sizes of 2 billion parameters, 8 billion parameters, and 13 billion parameters, facilitating flexibility in deployment across different device capabilities. In one or more implementations, high-quality operating system navigation data is collected, and an in-depth analysis is conducted to evaluate model performance concerning data quantity, data quality, and cross-domain platform applicability.

In one or more implementations, the integration of vision, language, and action processes can allow the autonomous UI agent of the subject technology to interpret human commands through natural language and visual inputs processed in parallel, outputting actions for automated device control. The multi-modal LLM can enable the autonomous UI agent to execute a range of navigation tasks on mobile platforms by interpreting commands and responding to visual UI elements.

The autonomous UI agent can support both multi-step navigation and single-step navigation. Multi-step navigation may involve the execution of sequential actions to achieve a broader objective, while single-step navigation may allow the agent to perform individual tasks based on distinct instructions. This functionality includes a user intent prediction component, which facilitates the autonomous UI agent to summarize and infer user goals, enhancing interaction versatility.

Synthetic data generation may be applied to address common navigation errors, such as incorrect tap locations or repeated actions, by incorporating simulated data into the training process to improve robustness of the autonomous UI agent. This data-driven approach may allow the autonomous UI agent to develop replanning capabilities, autonomously adjusting action pathways in response to errors encountered during UI navigation.

The development process may further include an exploration mechanism powered by large language model modules for autonomous data collection. In one or more implementations, the exploration mechanism may generate training data at scale, incorporating noise and variability that enhance the large language model's resilience in unpredictable environments.

The autonomous UI agent may also utilize chain-of-thought reasoning, incorporating reasoning traces that facilitate multi-step logical thinking aligned with task objectives. This reasoning component can enhance the autonomous UI agent's decision-making accuracy and reliability in complex navigation scenarios.

In one or more implementations, these features—the multi-modal language-vision integration, adaptability through synthetic data and reasoning trace mechanisms, and scalable auto-data generation—form an architecture that facilitates accurate, autonomous mobile navigation. This configuration can promote robust and scalable interaction capabilities on mobile devices.

Implementations of the subject technology improve the ability of a given electronic device to provide machine-learning generated data to a user (e.g., a user of the given electronic device). These benefits therefore are understood as improving the computing functionality of a given electronic device, such as an end user device which may generally have less computational and/or power resources available than, e.g., one or more cloud-based servers. For example, the subject system may provide for efficient utilization of processing and/or memory resources on an electronic device.

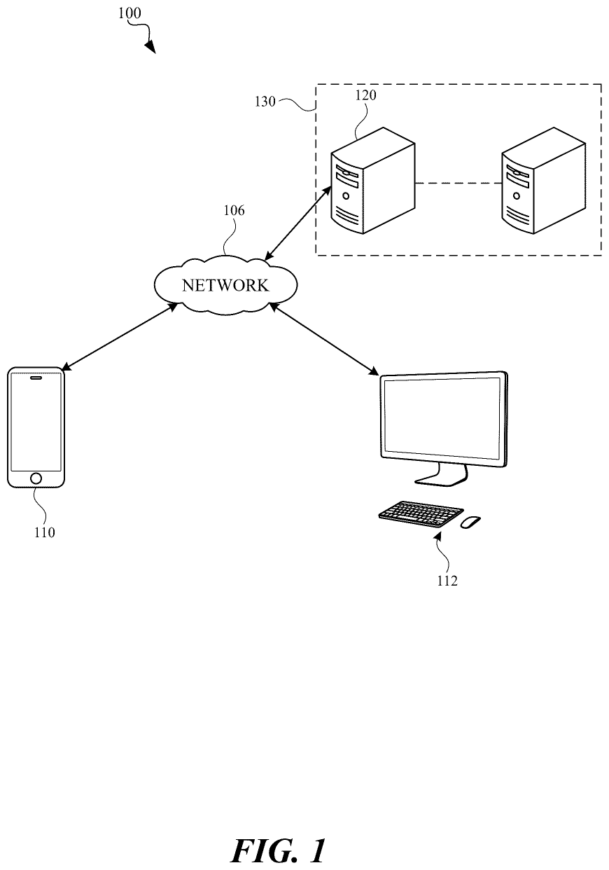

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 110, an electronic device 112, and a server 120. The network 106 may communicatively (directly or indirectly) couple the electronic device 110 and/or the server 120. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 112, and the server 120; however, the network environment 100 may include any number of electronic devices and any number of servers or a data center including multiple servers.

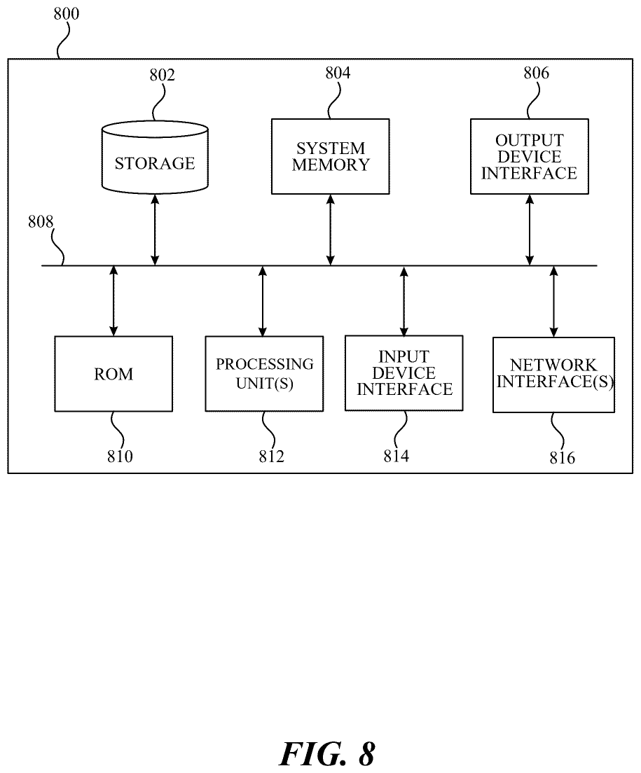

The electronic device 110 may be, for example, a desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 110 is depicted as a mobile electronic device (e.g., smartphone). The electronic device 110 may be, and/or may include all or part of, the electronic system discussed below with respect to FIG. 8.

The electronic device 112 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 112 is depicted as a desktop computer. The electronic device 112 may be, and/or may include all or part of, the electronic system discussed below with respect to FIG. 8.

In the example of FIG. 1, the electronic device 110 is depicted as a smartphone. However, it is appreciated that the electronic device 110 may be implemented as another type of device, such as a wearable device (e.g., a smart watch or other wearable device). The electronic device 110 may be a device of a user (e.g., the electronic device 110 may be associated with and/or logged into a user account for the user at a server). Although a single electronic device 110 is shown in FIG. 1, it is appreciated that the network environment 100 may include more than one electronic device, including more than one electronic device of a user and/or one or more other electronic devices of one or more other users.

The server 120 may form all or part of a network of computers or a group of servers 130, such as in a cloud computing or data center implementation. For example, the server 120 stores data and software, and includes specific hardware (e.g., processors, graphics processors and other specialized or custom processors, such as neural processors) for rendering and generating content such as graphics, images, video, audio and multi-media files. In an implementation, the server 120 may function as a cloud storage server that stores any of the aforementioned content generated by the above-discussed devices and/or the server 120.

In one or more implementations, one or more of the electronic devices 110-112 may provide a system for training a machine learning model using training data, where the trained machine learning model is subsequently deployed to one or more of the electronic devices 110-112. Further, one or more of the electronic devices 110-112 may provide one or more machine learning frameworks for training machine learning models and/or developing applications using such machine learning models. In an example, such machine learning frameworks can provide various machine learning algorithms and models for different problem domains in machine learning. In an example, the electronic device 110 may include a deployed machine learning model that provides an output of data corresponding to a prediction or some other type of machine learning output. In one or more implementations, training and inference operations that involve individually identifiable information of a user of one or more of the electronic devices 110-112 may be performed entirely on the electronic devices 110-112, to prevent exposure of individually identifiable data to devices and/or systems that are not authorized by the user.

The server 120 may provide a system for training a machine learning model using training data, where the trained machine learning model is subsequently deployed to the server 120 and/or to one or more of the electronic devices 110-112. In an implementation, the server 120 may train a given machine learning model for deployment to a client electronic device (e.g., the electronic device 110, the electronic device 112). In one or more implementations, the server 120 may train portions of the machine learning model using (e.g., anonymized) training data from a population of users, and one or more of the electronic devices 110-112 may train portions of the machine learning model using individual training data from the user of the electronic devices 110-112. The machine learning model deployed on the server 120 and/or one or more of the electronic devices 110-112 can then perform one or more machine learning algorithms. In an implementation, the server 120 provides a cloud service that utilizes the trained machine learning model and/or continually learns over time.

With recent advancements in large language models and multi-modal foundation models, autonomous agents capable of controlling mobile devices to execute tasks typically performed by humans are emerging. Existing implementations operate either on complex agentic workflow paradigms, which present challenges in optimization and result in slower inference, or on end-to-end models that rely on offline datasets annotated by human references. These offline datasets are limited in their ability to reflect actual mobile performance, particularly when managing erroneous actions, such as incorrect tap locations. Additionally, the limited availability of high-quality operating system data has constrained exploration of autonomous agents across a range of mobile devices.

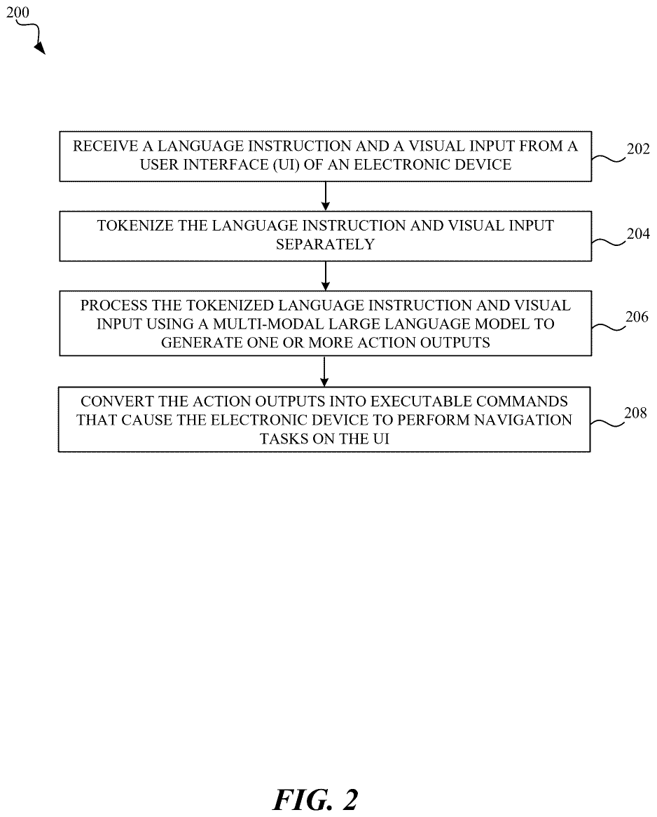

To address these limitations, an autonomous UI agent implemented as an LLM agent can serve as an end-to-end VLA model that executes various mobile navigation tasks. The operations performed by the autonomous UI agent, at least in part, will be described with reference to FIG. 2.

FIG. 2 is a flow chart of an example process 200 that may be performed for end-to-end mobile user interface navigation with vision language action models in accordance with one or more implementations. For explanatory purposes, the process 200 is primarily described herein with reference to the electronic device 110 of FIG. 1. However, the process 200 is not limited to the electronic device 110 of FIG. 1, and one or more blocks (or operations) of the process 200 may be performed by one or more other components of other suitable devices and/or servers. Further for explanatory purposes, some of the blocks of the process 200 are described herein as occurring in serial, or linearly. However, multiple blocks of the process 200 may occur in parallel. In addition, the blocks of the process 200 need not be performed in the order shown and/or one or more blocks of the process 200 need not be performed and/or can be replaced by other operations.

At 202, an apparatus may receive a language instruction and a visual input from a user interface of an electronic device (e.g., electronic device 110 of FIG. 1). In one or more implementations, the visual input is processed using an image encoder. The image encoder may be configured to resize and divide the visual input based on an orientation of the UI, and tokenize both a full resized image and at least one sub-image derived from the visual input.

At 204, the apparatus may tokenize the language instruction and visual input separately.

At 206, the apparatus may process the tokenized language instruction and visual input using a multi-modal large language model to generate one or more action outputs. In one or more implementations, the action outputs are in a pre-defined format. In one or more other implementations, the executable commands are configured to perform one or more of a tap, scroll, input, or swipe action on the UI of the electronic device.

At 208, the apparatus may convert the action outputs into executable commands that cause the electronic device to perform navigation tasks on the user interface.

In one or more implementations, the apparatus may generate synthetic training data to augment a core data set for training the multi-modal large language model. In one or more other implementations, the synthetic training data is generated by simulating navigation errors that occur on the UI of the electronic device. The navigation errors may include one or more of an incorrect tap location, inputting text without a corresponding active text field, or performing an excessive scroll action when a page boundary is reached. In generating the synthetic training data, in one or more other implementations, the apparatus may use user-annotated data to create failure scenarios. The synthetic training data can be generated by perturbing a tap location to fall outside a UI element boundary defined by the user-annotated data.

In one or more implementations, the apparatus may generate reasoning traces for the multi-modal large language model. The reasoning traces can guide the multi-modal large language model in a sequence of decision-making steps for multi-step tasks to enhance accuracy in completing the navigation tasks.

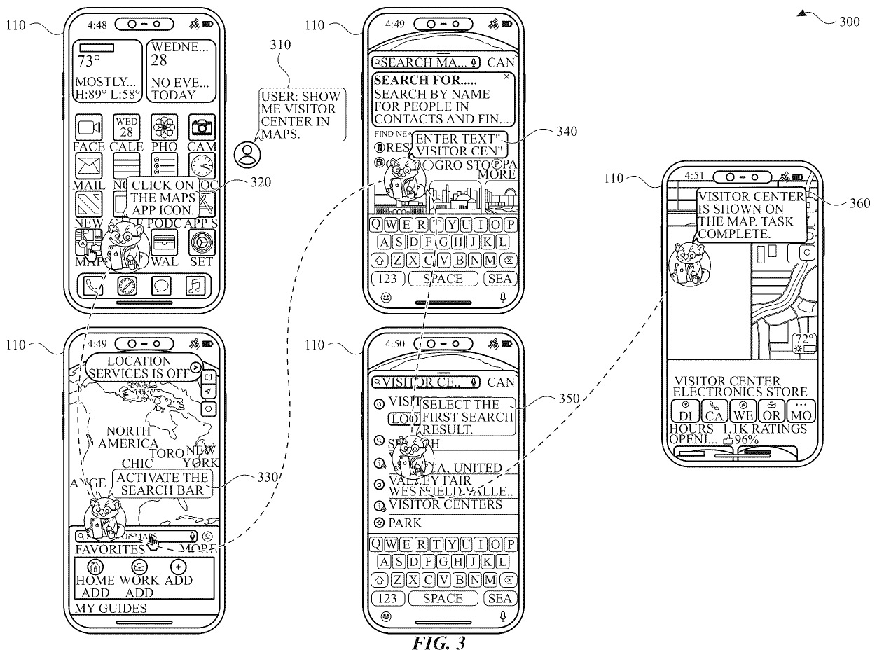

FIG. 3 illustrates an example multi-step navigation flow 300 for end-to-end mobile user interface navigation with vision language action models in accordance with one or more implementations. In one or more implementations, the autonomous UI agent may function as an end-to-end VLA model that executes various mobile navigation tasks. An example of multi-step navigation is depicted, in which human users can provide a high-level goal in plain text along with the initial mobile screenshot. The autonomous UI agent autonomously manages the mobile device operations across multiple steps until task completion is indicated. In one or more implementations, the autonomous UI agent may accommodate single-step navigation, which involves performing a single interaction with the mobile device based on a user-provided step instruction. In one or more other implementations, it supports user intent prediction, summarizing the user's intent following the recording of an action.

The autonomous UI agent is introduced as a family of lightweight, end-to-end vision-language action (VLA) models designed specifically for various mobile UI navigation tasks, including multi-step navigation, single-step navigation, and user intent prediction, as illustrated in FIG. 3. In one or more implementations, the autonomous UI agent may receive an audio-based user-provided step instruction. For example, at step instruction 310, the user may instruct the autonomous UI agent with the user-provided step instruction indicating “Show me the Visitor Center in the Map app.” At step instruction 320, the autonomous UI agent may trigger a multi-step navigation and display a first pop-up window indicating a navigation instruction, “Click on the Map app icon”, as part of a first step of the multi-step navigation. The pop-up window may be superimposed (or overlaid) on a home screen of the electronic device 110. At step instruction 330, the autonomous UI agent then proceeds to display a landing page of the map application running on the electronic device 110 and a second pop-up window superimposed on the landing page of the map application. The second pop-up window may indicate another navigation instruction, “Activate the search bar”, as part of a second step of the multi-step navigation. At step instruction 340, the autonomous UI agent then proceeds to display a search window of the map application and a third pop-up window superimposed on at least a portion of the search window. The third pop-up window may indicate another navigation instruction, “Enter text ‘Visitor Center’”, as part of a third step of the multi-step navigation. At step instruction 350, the autonomous UI agent then proceeds to display a search results listing within the search window and a fourth pop-up window superimposed on at least a portion of the search window. The fourth pop-up window may indicate another navigation instruction, “Select the first search result”, as part of a fourth step of the multi-step navigation. At step instruction 360, the autonomous UI agent then proceeds to display a map of the selected location and a fifth pop-up window superimposed on at least a portion of the map. The fifth pop-up window may indicate another navigation instruction, “Visitor Center is shown on the map. Task complete.”, as part of a final step of the multi-step navigation. In one or more implementations, the autonomous UI agent can map raw UI screenshots directly to executable actions, enabling closed-loop mobile device control and bypassing the need for complex modular configurations.

In one or more implementations, the autonomous UI agent can optimize the balance between navigation accuracy and inference speed through a structured output format and constrained model size. The autonomous UI agent can be based on a vision-language model developed for general mobile UI understanding and can be fine-tuned using mobile navigation episodes. In one or more implementations, a human-annotated operating system navigation dataset (e.g., of over 6,000 episodes) can be constructed for training with an additional subset of episodes (e.g., about 500 episodes) dedicated to evaluation. This dataset may undergo multiple rounds of quality control and include navigation scenarios across widely used first-party applications and third-party applications, with episode goals representing primary application functions.

Using the human-annotated operating system navigation dataset, along with publicly available operating system datasets, extensive offline evaluations may be conducted to assess the effects of model size, data quantity and quality, and cross-domain transfer performance between operating system (OS) and OS-specific devices.

In online mobile navigation involving closed-loop control, the capability to replan after errors—such as tapping incorrect UI elements or scrolling in unintended directions—can be beneficial. To incorporate replanning capabilities, the autonomous UI agent may predict expected action outcomes and learn to address previous mistakes by training on a specialized replanning dataset. This replanning dataset may combine human demonstrations, synthetic data generation, and auto-labeling methods.

In one or more implementations, the UI navigation can be formulated as a visual question answering (VQA) problem. In this approach, a UI screenshot image of a current step and its corresponding instruction question are provided as inputs to a multi-modal LLM. The multi-modal LLM can predict output actions in pre-defined formats, which can be parsed into executable functions, facilitating closed-loop mobile device control. In one or more implementations, the multi-modal LLM can undergo training through imitation learning, utilizing pre-recorded traces to refine its navigation capabilities.

To facilitate instruction following and text parsing in UI navigation, several textual components can be defined. In one or more implementations, an episode goal is a component that may consist of a natural language description of a task that the UI agent can accomplish, involving multi-step interactions. An example of an episode goal is, “Turn my display to dark mode.” In one or more other implementations, a step goal is a component that may include a natural language description of a task that involves a single UI screen interaction. A step goal can specify the action along with spatial information, referred to as a step instruction. For example, “Click on the Maps icon on the bottom left of the screen.” The step goal can convey the abstract user intent, known as user intent. For example, “Open Maps for me” can be interpreted as asking for assistance in executing an action. In one or more other implementations, an Action may refer to the interaction with mobile devices. The action space in autonomous UI agent encompasses six distinct actions. In one or more other implementations, an action result is a component that represents the outcomes of performing an action, such as “Tap succeeded” or “Wrong texts entered.” The action result may be generated directly by the agent model as the expected result of the predicted action or obtained through an external evaluator or critic model in a closed-loop navigation setting. In one or more other implementations, history traces may describe the previous interaction sequences between an agent and a mobile device, including prior step instructions, actions, and action results.

By constructing question-answer (QA) pairs utilizing various combinations of the textual components outlined above, three practical UI navigation tasks can be included in the autonomous UI agent. These tasks may include multi-step navigation, single-step navigation, and user intent prediction. All three tasks can utilize the UI screenshot image of the current step as the input image for the model.

The multi-step navigation task can be implemented through a predict-action loop. At each step, the autonomous UI agent can utilize the episode goal and history traces as input texts to predict the step goal, action, and action result. Following the execution of an action on the mobile device (e.g., the electronic device 110), the outputs from the model can be appended to the history traces for the next round of navigation. The agent model can continue this predict-action loop until it predicts a terminate state or reaches the maximum number of iterations.

The single-step navigation task takes the step goal as an input question and predicts an action for a single-round interaction with the mobile device. In one or more other implementations, the single-step navigation may necessitate the step goal to be provided by a user. This functionality allows users to control mobile devices in a hands-free manner, enhancing various accessibility features. In single-step navigation, either step instructions or user intents are randomly selected as input questions, while user intent prediction utilizes user intents as output answers. To enhance training diversity in multi-step navigation, several VQA variants may be employed by masking out various textual components, including history traces, step goals, and action results.

The user-intent prediction task may function as the inverse of single-step navigation. In this scenario, the multi-modal LLM can receive recorded actions from human users as inputs and can predict the associated user intent. This task may significantly enhance dialog agents by offering valuable feedback on the success or failure of their actions, addressing a core challenge in comprehensive UI understanding. One potential application involves generating user guidance for new devices and applications, where mobile devices demonstrate navigation techniques on phones. These demonstrations, which include low-level action policies, may be converted into user intents that can be followed by new phone users.

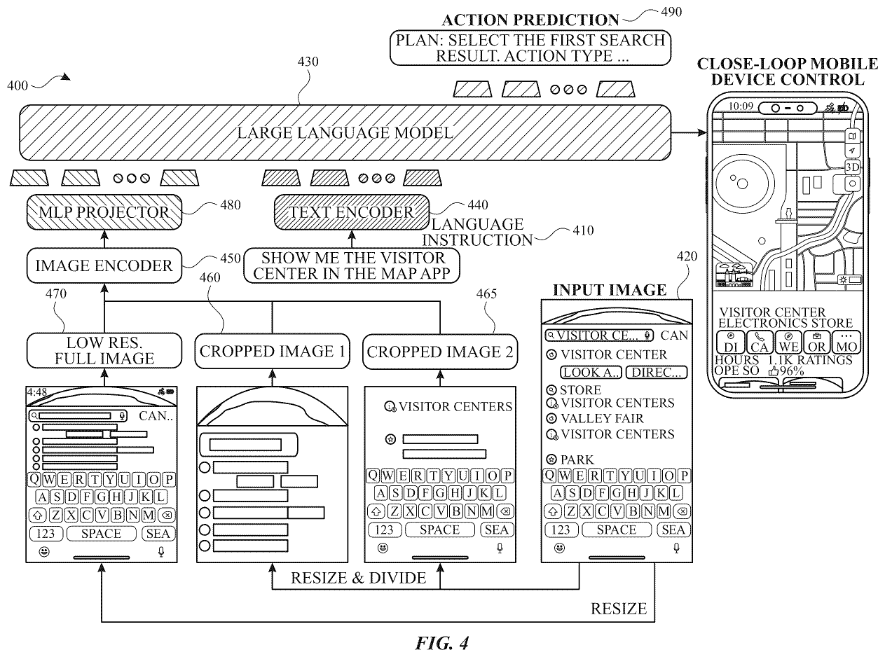

FIG. 4 illustrates a block diagram of an example autonomous UI agent architecture 400 for end-to-end mobile user interface navigation with vision language action models in accordance with one or more implementations. The autonomous UI agent architecture 400 may process a language instruction 410 and an input image 420 (e.g., a UI screenshot) as inputs, producing actions in predefined formats via a multi-modal LLM transformer decoder (e.g., large language model 430). These inputs are processed by a pretrained textual encoder 440 and a visual encoder 450. The predicted actions can undergo conversion into executable functions (or executable commands) for closed-loop control of mobile devices. The language instruction 410 and input image 420 can be tokenized independently before being input into the multi-modal LLM transformer decoder 430. To achieve accurate and fine-grained understanding of UI scenes, an any-resolution technique can be employed to process images. Each image is resized and segmented into two sub-images (e.g., cropped image 460, cropped image 465) based on its orientation (e.g., horizontal or portrait) on the UI. These sub-images (e.g., cropped image 460, cropped image 465), along with a resized low-resolution full image 470, are then tokenized by the same image encoder and subsequently projected into text space using a multi-layer perceptron (MLP) projector 480.

Action outputs 490 may be predicted in plain text from the multi-modal LLM transformer decoder, which are subsequently converted into function calls for closed-loop mobile device control. The bounding box encoding strategy can be utilized to encode tap locations locx and locy, facilitating the transfer of grounding capabilities to action predictions within the autonomous UI agent. Specifically, an image screen can be discretized into a grid of 1000×1000 pixels. The large language model 430 directly outputs the pixel values of a bounding box in the format [x₁,y₁,x₂,y₂], where the center of this bounding box is converted into tap locations locx and locy.

In one or more implementations, the textual outputs may be short, concise, and adhere to pre-defined patterns. In one or more implementations, simple action outputs facilitate simplified learning and parsing into function calls for mobile navigation. Empirical data may indicate that the multi-modal LLM transformer decoder may rapidly learn to follow output patterns without specific constraints, such as valid token sampling. In one or more implementations, concise action outputs, which minimize token consumption, reduce inference time, benefiting the interactive user experience associated with mobile navigation. An example of the action output format includes: “Plan: click on the maps icon. Action type: tap. Location: [50, 88, 70, 108]. Action result: tap succeeded.”

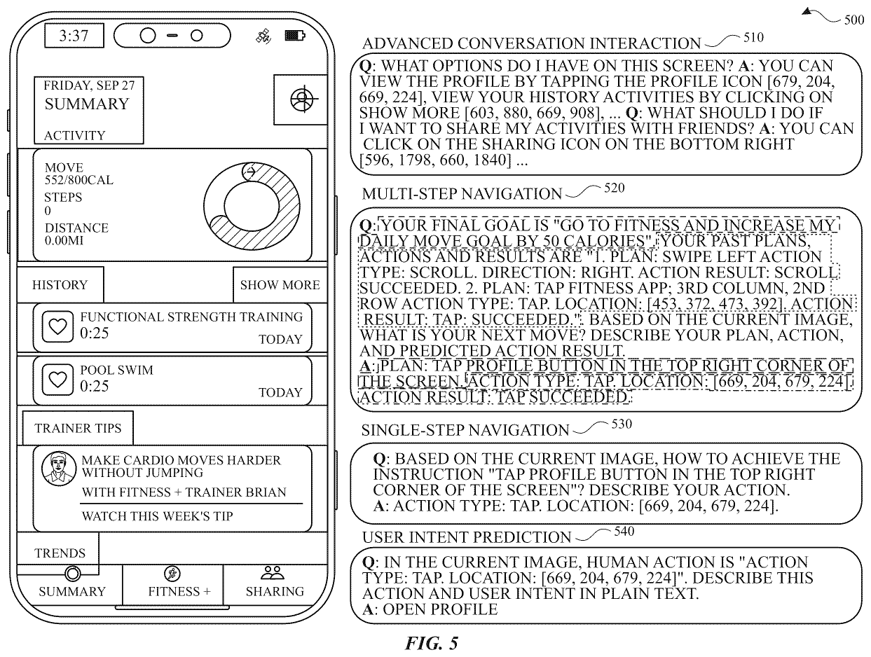

FIG. 5 illustrates example visual question answering format 500 for training a large language model agent for end-to-end mobile user interface navigation with vision language action models in accordance with one or more implementations. In one or more implementations, VQA formats may train the autonomous UI agent model family. The autonomous UI agent of the subject technology may include advanced conversational interaction 510 that utilizes a separate UI detection model for generating bounding boxes, which can be employed during training. To enhance training diversity for multi-step navigation 520, various VQA versions are created by randomly masking certain textual components from the history traces, step goal, and action result. In the context of training for single-step navigation 530, step instruction and user intent can be randomly selected to formulate questions. The autonomous UI agent can support both multi-step navigation 520 and single-step navigation 530. Multi-step navigation 520 may involve the execution of sequential actions to achieve a broader objective, while single-step navigation 530 may allow the autonomous UI agent to perform individual tasks based on distinct instructions. This functionality includes a user intent prediction 540, which facilitates the autonomous UI agent to summarize and infer user goals, enhancing interaction versatility.

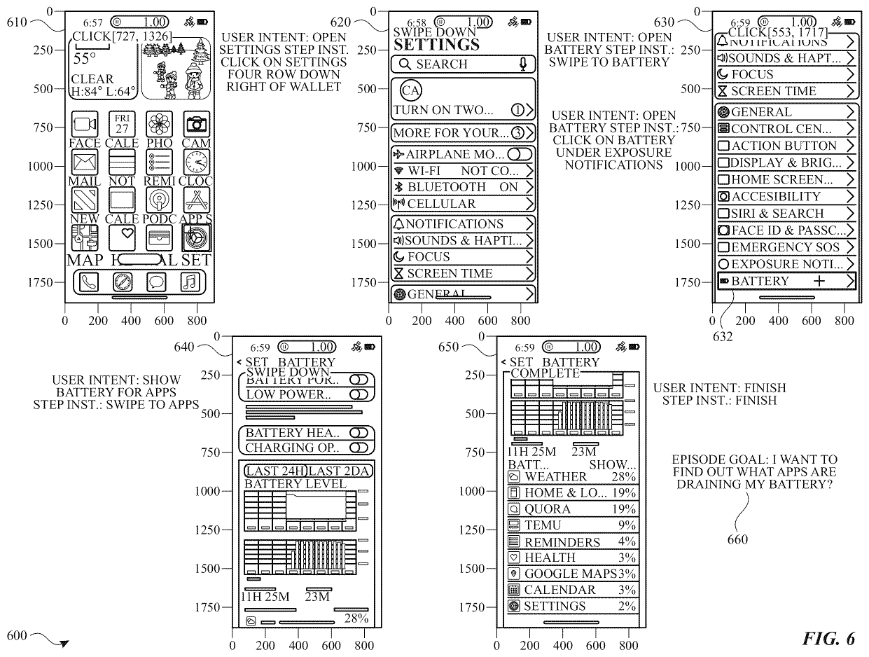

FIG. 6 illustrates an example human-annotated episode flow 600 for end-to-end mobile user interface navigation with vision language action models in accordance with one or more implementations. A human-annotated episode example is provided, consisting of an episode goal, step instruction, user intent, action recordings, and bounding boxes delineating the UI elements. These annotations may facilitate the analysis of the tap action, which results in a change of state within the same UI screenshot. The episode goal can specify the overall objective of the interaction, while the step instruction details the specific action to be taken. The user intent reflects the underlying motivation for the action, and the action recordings document the executed commands. The bounding boxes assist in identifying the precise locations of the UI elements affected by the tap action, enabling a clear understanding of the resultant state change.

As illustrated in FIG. 6, an episode goal 660 indicates that a user wants to find out what apps are draining the battery of the electronic device 110. The human-annotated episode flow 600 may begin at step instruction 610 indicating that the user intent is to open the settings application of the electronic device 110. At step instruction 610, the human-annotated episode flow 600 may start at a home screen of the electronic device 110. The step instruction 610 may indicate to the user to click on the settings icon located four rows down and to the immediate right of a wallet application. The human-annotated episode flow 600 may proceed to step instruction 620 indicating that the user intent is to open the battery settings of the electronic device 110. The step instruction 620 may indicate to the user to swipe down to the battery settings icon. The human-annotated episode flow 600 may proceed to step instruction 630 indicating that the user intent remains to open the battery settings of the electronic device 110. The step instruction 630 may indicate to the user to select the battery settings by clicking on the battery settings icon. A bounding box 632 may be displayed to facilitate the selection of the battery settings within the settings application. The human-annotated episode flow 600 may proceed to step instruction 640 indicating that the user intent is to show the battery usage for all applications running on the electronic device 110. The step instruction 640 may indicate to the user to swipe down to the applications section of the battery settings. The human-annotated episode flow 600 may proceed to step instruction 650 indicating that the multi-step navigation is complete. At step instruction 650, the autonomous UI agent may display an ordered listing of the applications and their corresponding power consumption values.

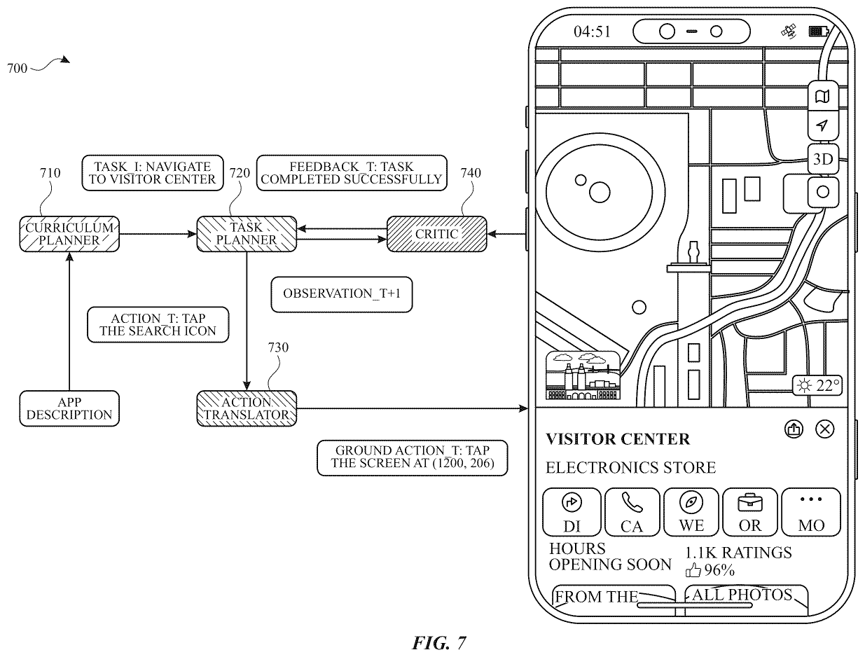

The collection of OS navigation datasets in one or more implementations aims to achieve two primary objectives: (1) the development of UI agents capable of performing diverse navigation tasks and (2) the quantification of navigation performance on OS-specific devices. The core data of the OS navigation dataset may consist of clean, human-annotated episodes documenting mobile device interactions. Each episode captures a high-level task, a discrete sequence of UI screenshots, and the associated actions, along with step-level human annotations. In one or more other implementations, to train agents with replanning capabilities, human-annotated episodes featuring specific workflows are collected. The OS navigation dataset may be further enhanced by incorporating synthetically generated replanning data and auto-labeled data obtained through an exploration mechanism, which will be described with reference to FIG. 7.

The core data may be collected using an annotation tool that interfaces with OS-specific devices to control their functionality. This tool can record (or store) a UI screenshot and the associated action each time an action is triggered. A human annotator may randomly explore the targeted applications pre-installed on OS-specific devices to become familiar with common use cases and the navigation action space. Following this familiarization, the human annotators are assigned a variety of practice tasks, and their annotations can be evaluated according to a guideline. Throughout data collection, episodes are randomly sampled, and feedback for improvements can be provided to the annotators.

In one or more implementations, human annotators can be instructed to complete an episode with clean traces, avoiding redundant steps that complicate the traces unnecessarily. For example, instead of searching for the voiceover settings by trying multiple setting options, the human annotators are directed to go directly to the accessibility menu. High-level episode goals and low-level step goals, which include step instructions and user intents, are articulated in concise, descriptive language to eliminate ambiguity. In one or more other implementations, each UI element associated with a tap action may be annotated with a tightly-fixed bounding box, which serves two purposes: it is utilized in synthetic data generation and facilitates offline evaluation for accurate matching criteria.

In a single-task workflow, each annotation task can be linked to a specific target episode goal, which can be either directly created by human users for application development or pre-generated by one or more LLMs using concrete templates that are subsequently refined by human users. Examples of these templates include phrases such as “{Find, Search, Show, Check} [symbol] object [symbol] in [symbol] app [symbol] ” and “{Share, Send} [symbol] object [symbol] from [symbol] app [symbol] .” These single-step episode goals may reflect the most common applications of an application.

In a multi-task workflow, human annotators explore a specific application or multiple applications in sequence, creating episodes with clean traces during the exploration process. This approach can increase the number of episodes for building the training dataset while naturally recording traces that are beneficial for replanning. For example, when exploring the “Settings” application, human annotators can first create an episode to enable location services and then create another episode to enable a voice-over feature. To complete the second episode, the human annotators can document several steps to navigate back to the main settings page from a “Privacy and Security” setting before accessing the accessibility setting. By training on these transition steps, the multi-modal LLM can learn to navigate back from screenshots that deviate from the clean paths associated with the targeted episode goals.

In one or more implementations, top first-party applications and third-party applications can be selected based on their popularity. To enhance data diversity, each annotation task utilizes randomized OS-specific device versions, incorporating various image resolutions, aspect ratios, and initial settings, such as wallpaper and light/dark mode. This dataset can encompass several first-party applications as well as third-party applications.

Synthetic data can be generated to augment the training dataset, which assists autonomous UI agents in replanning after executing erroneous actions. In one or more implementations, failure cases can be identified where executing an action does not produce any screen effects: (1) slight grounding errors occur when the predicted tap location is misaligned with the UI element, resulting in no tap effect; (2) autonomous UI agents attempt to enter text using the input text action before the text field is activated; (3) autonomous UI agents continue to predict scroll actions while browsing an application, despite having reached the top or bottom of the page. These failure cases may not generate additional screenshots; therefore, the human annotation data (e.g., core data) can be reused for synthetic data generation. Each replanning step is created based on a synthetic failure step, such as clicking on the search bar after the action input text is predicted. For tap replanning, synthetic failure steps are generated by perturbing the tap location outside the human-annotated UI element bounding boxes.

FIG. 7 illustrates a block diagram of an exploration mechanism 700 to generate auto-label data for end-to-end mobile user interface navigation with vision language action models in accordance with one or more implementations. Manual data collection may present challenges related to speed and scalability; therefore, auto-data generation can be employed through an exploration mechanism. Automating the data collection process enables the introduction of additional supervision for model training, such as enhancing robustness to noise and stochasticity in the environment, as well as generating reasoning traces to improve the decision-making capabilities of the autonomous UI agent of the subject technology.

The exploration mechanism 700 may include four different modules (e.g., curriculum planner module 710, task planner module 720, action translator module 730, critic module 740), three of which utilize LLMs configured for automatic application exploration and the generation of supervised training data for autonomous UI agent training. To enhance the robustness of the autonomous UI agent to unfavorable initial states, random actions may be injected during the exploration process, and the resulting post-recovery trajectories are used for the autonomous UI agent training. In one or more implementations, utilizing internal representations to refine LLM outputs through chain-of-thought elicitation can improve task accuracy for downstream applications. The autonomous UI agent can be trained to produce these reasoning traces alongside the action outputs.

FIG. 8 illustrates an electronic system 800 with which one or more implementations of the subject technology may be implemented. The electronic system 800 can be, and/or can be a part of, any one of the electronic devices 110-112, and/or the server 120 shown in FIG. 1. The electronic system 800 may include various types of computer readable media and interfaces for various other types of computer readable media. The electronic system 800 includes a bus 808, one or more processing unit(s) 812, a system memory 804 (and/or buffer), a ROM 810, a permanent storage device 802, an input device interface 814, an output device interface 806, and one or more network interfaces 816, or subsets and variations thereof.

The bus 808 collectively represents all system, peripheral, and chipset buses that communicatively connect the numerous internal devices of the electronic system 800. In one or more implementations, the bus 808 communicatively connects the one or more processing unit(s) 812 with the ROM 810, the system memory 804, and the permanent storage device 802. From these various memory units, the one or more processing unit(s) 812 retrieves instructions to execute and data to process in order to execute the processes of the subject disclosure. The one or more processing unit(s) 812 can be a single processor or a multi-core processor in different implementations.

The ROM 810 stores static data and instructions that are needed by the one or more processing unit(s) 812 and other modules of the electronic system 800. The permanent storage device 802, on the other hand, may be a read-and-write memory device. The permanent storage device 802 may be a non-volatile memory unit that stores instructions and data even when the electronic system 800 is off. In one or more implementations, a mass-storage device (such as a magnetic or optical disk and its corresponding disk drive) may be used as the permanent storage device 802.

In one or more implementations, a removable storage device (such as a flash drive, and its corresponding solid-state drive) may be used as the permanent storage device 802. Like the permanent storage device 802, the system memory 804 may be a read-and-write memory device. However, unlike the permanent storage device 802, the system memory 804 may be a volatile read-and-write memory, such as random-access memory. The system memory 804 may store any of the instructions and data that one or more processing unit(s) 812 may need at runtime. In one or more implementations, the processes of the subject disclosure are stored in the system memory 804, the permanent storage device 802, and/or the ROM 810. From these various memory units, the one or more processing unit(s) 812 retrieves instructions to execute and data to process in order to execute the processes of one or more implementations.

The bus 808 also connects to the input device interface 814 and output device interface 806. The input device interface 814 enables a user to communicate information and select commands to the electronic system 800. Input devices that may be used with the input device interface 814 may include, for example, alphanumeric keyboards and pointing devices (also called “cursor control devices”). The output device interface 806 may enable, for example, the display of images generated by electronic system 800. Output devices that may be used with the output device interface 806 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 8, the bus 808 also couples the electronic system 800 to one or more networks and/or to one or more network nodes, such as the electronic device 110 shown in FIG. 1, through the one or more network interface(s) 816. In this manner, the electronic system 800 can be a part of a network of computers (such as a LAN, a wide area network (“WAN”), or an Intranet, or a network of networks, such as the Internet. Any or all components of the electronic system 800 can be used in conjunction with the subject disclosure.

One or more implementations described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in one or more implementations, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In one or more implementations, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In one or more implementations, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In one or more implementations, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In one or more implementations, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In one or more implementations, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In one or more implementations, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In one or more implementations, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In one or more implementations, novel automatically-generated content that is generated via one or more AI processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as LLMs. Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In one or more implementations, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In one or more implementations, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules and/or components.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display”or “displaying”means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
receiving a language instruction and a visual input from a user interface (UI) of an electronic device;
tokenizing the language instruction and the visual input separately;
processing the tokenized language instruction and the tokenized visual input using a multi-modal large language model to generate one or more action outputs; and
converting the action outputs into executable commands that cause the electronic device to perform navigation tasks on the UI.

2. The method of claim 1, wherein the action outputs are in a pre-defined format, and wherein the executable commands are configured to perform one or more of a tap, scroll, input, or swipe action on the UI of the electronic device.

3. The method of claim 1, wherein the visual input is processed using an image encoder, wherein the image encoder is configured to:
resize and divide the visual input based on an orientation of the UI, and
tokenize both a full resized image and at least one sub-image derived from the visual input.

4. The method of claim 1, further comprising:
generating synthetic training data to augment a core data set for training the multi-modal large language model, wherein the synthetic training data is generated by simulating navigation errors that occur on the UI of the electronic device, wherein the navigation errors comprise one or more of an incorrect tap location, inputting text without a corresponding active text field, or performing an excessive scroll action when a page boundary is reached.

5. The method of claim 4, wherein generating the synthetic training data further comprises using user-annotated data to create failure scenarios, wherein the synthetic training data is generated by perturbing a tap location to fall outside a UI element boundary defined by the user-annotated data.

6. The method of claim 1, further comprising generating reasoning traces for the multi-modal large language model, wherein the reasoning traces guide the multi-modal large language model in a sequence of decision-making steps for multi-step tasks to enhance accuracy in completing the navigation tasks.

7. A system, comprising:
a tokenization module configured to independently tokenize a language instruction and a visual input captured from a user interface (UI) on an electronic device;
a multi-modal large language model configured to:
receive tokenized inputs from the tokenization module,
generate action outputs based on the tokenized inputs, and
output the action outputs in a pre-defined format; and
an execution module configured to interpret the action outputs as executable commands, the executable commands further configured to navigate the UI of the electronic device based on the language instruction and the visual input.

8. The system of claim 7, further comprising an exploration mechanism for generating auto-data by executing one or more simulated tasks on the UI of the electronic device, the exploration mechanism comprising:
at least one large language model module configured to autonomously navigate the UI and record task completion traces;
an injection module configured to introduce random actions within a task sequence to simulate recovery from adverse states; and
a training module configured to apply the task completion traces and injected adverse-state recovery traces for training the multi-modal large language model.

9. The system of claim 7, wherein the multi-modal large language model uses reasoning traces and the action outputs, the reasoning traces representing logical, stepwise sequences for completing navigation tasks on the UI of the electronic device.

10. The system of claim 7, wherein the executable commands are configured to perform one or more of a tap, scroll, input, or swipe action on the UI of the electronic device.

11. The system of claim 7, wherein the visual input is processed using an image encoder, wherein the image encoder is configured to:
resize and divide the visual input based on an orientation of the UI, and
tokenize both a full resized image and at least one sub-image derived from the visual input.

12. The system of claim 7, further comprising:
generating synthetic training data to augment a core data set for training the multi-modal large language model, wherein the synthetic training data is generated by simulating navigation errors that occur on the UI of the electronic device, wherein the navigation errors comprise one or more of an incorrect tap location, inputting text without a corresponding active text field, or performing an excessive scroll action when a page boundary is reached.

13. The system of claim 12, wherein generating the synthetic training data further comprises using user-annotated data to create failure scenarios, wherein the synthetic training data is generated by perturbing a tap location to fall outside a UI element boundary defined by the user-annotated data.

14. The system of claim 7, further comprising generating reasoning traces for the multi-modal large language model, wherein the reasoning traces guide the multi-modal large language model in a sequence of decision-making steps for multi-step tasks to enhance accuracy in completing navigation tasks.

15. A non-transitory machine-readable medium comprising code that, when executed by a processor, causes the processor to perform operations comprising:
capturing a language instruction and a visual input from a user interface (UI) on an electronic device;
tokenizing the language instruction and the visual input separately;
processing the tokenized language instruction and the tokenized visual input with a multi-modal large language model to produce one or more action outputs in a pre-defined format;
converting the action outputs into executable commands that perform navigation tasks on the UI; and
generating synthetic data to train the multi-modal large language model by injecting adverse actions into task sequences.

16. The non-transitory machine-readable medium of claim 15, wherein the adverse actions comprise off-target taps, premature input actions, or excessive scroll actions beyond a UI boundary.

17. The non-transitory machine-readable medium of claim 15, wherein the executable commands are configured to perform one or more of a tap, scroll, input, or swipe action on the UI of the electronic device.

18. The non-transitory machine-readable medium of claim 15, wherein the operations further comprise:
generating synthetic training data to augment a core data set for training the multi-modal large language model, wherein the synthetic training data is generated by simulating navigation errors that occur on the UI of the electronic device, wherein the navigation errors comprise one or more of an incorrect tap location, inputting text without a corresponding active text field, or performing an excessive scroll action when a page boundary is reached.

19. The non-transitory machine-readable medium of claim 18, wherein generating the synthetic training data further comprises using user-annotated data to create failure scenarios, wherein the synthetic training data is generated by perturbing a tap location to fall outside a UI element boundary defined by the user-annotated data.

20. The non-transitory machine-readable medium of claim 15, wherein the operations further comprise generating reasoning traces for the multi-modal large language model, wherein the reasoning traces guide the multi-modal large language model in a sequence of decision-making steps for multi-step tasks to enhance accuracy in completing the navigation tasks.
